(19) United States
(12) Patent Application Publication
(10) Pub. No.: US 2004/0014883 A1
(43) Pub. Date: Jan. 22, 2004

(54) Polyester film

(76) Inventors: Motonori Yamamoto, Mannheim (DE); Gabriel Skupin, Speyer (DE)

Correspondence Address: KEIL & WEINKAUF, 1350 CONNECTICUT AVENUE, N.W., WASHINGTON, DC, 20036, US

(21) Appl. No.: 10/380,119

(22) PCT Filed: Sep. 14, 2001
(86) PCT No.: PCT/EP01/10616

(30) Foreign Application Priority Data
Sep. 18, 2000 (DE) 100 46 398.3
Feb. 23, 2001 (DE) 101 08 985.6

(51) Int. Cl. C08K 3/00

(52) U.S. Cl. 524/599

(57) ABSTRACT

The present invention relates to polyester films comprising

i) from 70 to 99.9% by weight of at least one polyester with a molar mass Mₙ in the range from 8000 to 100,000 g/mol, and

ii) from 0.1 to 30% by weight of one or more compounds selected from

ii1) at least one surfactant and

ii2) polyesters with a molar mass Mₙ in the range from 1000 to 7000 g/mol

or a mixture made from one or more compounds ii1) and ii2),

where the percentages by weight of components i) to ii) give 100% in total,

and also to the use of these films as a packaging film, and also to the use of ii) for increasing the transparency or adhesion of polyester films or for improving their antifogging properties, or as a nucleating agent for polyesters.

The present invention relates to polyester films comprising

i) from 70 to 99.9% by weight of at least one polyester with a molar mass Mₙ in range from 8000 to 100,000 g/mol, and

ii) from 0.1 to 30% by weight of one or more compounds selected from

ii1) at least one surfactant and

ii2) polyesters with a molar mass Mₙ in the range from 1000 to 7000 g/mol

or a mixture made from one or more compounds ii1) and ii2),

where the percentages by weight of components i) to ii) give 100% in total.

The present invention further relates to the use of polyester films as packaging films, and also to the use of ii1) at least one surfactant or ii2) polyesters with a molar mass Mₙ in the range from 1000 to 7000 g/mol, or mixtures made from one or more compounds ii1) and ii2) for increasing the transparency or adhesion of polyester films, or improving their antifogging properties, or as a nucleating agent for polyesters.

The film materials mostly used to date for applications such as the packaging of biodegradable products like foods, are based on polyethylene, polypropylene or vinyl chloride homo- or copolymers. A disadvantage of these materials is that they are essentially nonbiodegradable. This means that their correct disposal is complicated and therefore expensive.

There are known biodegradable polyester films which do not have this disadvantage (see, for example, WO 96/15173). JP-A2 026626/00 and JP-A2 026623/00 describe biodegradable polyester films comprising aliphatic polyesters based on hydroxycarboxylic acids, and comprising liquid additives of a certain viscosity. However, when polyester films, in particular biodegradable polyester films, are compared with nonbiodegradable films based on polyethylene, on polypropylene or on vinyl chloride homo- or copolymers, the polyester films are less transparent and have lower adhesion, both with respect to other materials, such as cardboard packaging or foods, and with respect to themselves. They also have poorer antifogging properties.

It is an object of the present invention, therefore, to provide polyester films which have improved transparency, improved adhesion, improved antifogging properties, or two or more of these properties.

We have found that this object is achieved by means of the polyester films defined at the outset and described in greater detail below.

In principle, the components i) used in producing the polyester films of the invention may be any of the polyesters which have a molar mass Mₙ in the range from 8000 to 100,000 g/mol, preferably from 9000 to 75,000 g/mol, particularly preferably from 10,000 to 50,000 g/mol. Examples of polyesters of this type are polyethylene terephthalate and polybutylene terephthalate. Mixtures or blends of these polyesters are also suitable.

The method for determining the molecular weight Mₙ of these polymers and the polymers mentioned below is given in the “Examples” section later in this text, where the measurement of performance-related properties is described.

The polyester films of the invention are preferably biodegradable.

For the purposes of the present invention, the “biodegradable polyester films” is intended to include any of the polyester films which fall within the definition given in DIN V 54900 for biodegradability, and in particular to include compostible polyester films.

Biodegradability generally implies that the polyester films break down within an appropriate and demonstrable time span. The degradation may take place by hydrolysis and/or by oxidation and may predominantly be brought about by the action of microorganisms, such as bacteria, yeasts, fungi, or algae. One way of determining biodegradability is to mix films with compost and store them for a certain time. In ASTM D5338, ASTM D6400, and DIN V 54900 CO₂-free air, for example, is made to flow through ripened compost during the composting process and the compost is subjected to a prescribed temperature program. Biodegradability is defined here via the ratio of net CO₂ generation by the specimen (calculated after subtracting the CO₂ generated by the compost without the specimen) to the maximum CO₂ generation by the specimen (calculated from the specimen's carbon content). The polyester films of the invention, which are biodegradable, generally show clear signs of degradation after as little as a few days of composting, for example fungal growth, cracking and perforation.

In principle, the components i) used in producing the biodegradable polyester films of the invention may be any of the biodegradable polyesters which have a molar mass Mₙ in the range from 8000 to 100,000 g/mol, preferably from 9000 to 75,000 g/mol, particularly preferably from 10,000 to 50,000 g/mol. Examples of biodegradable polyesters are cellulose derivatives, for example cellulose esters, e.g. cellulose acetate and cellulose acetate butyrate, starch esters, and also polyesters, in particular aliphatic homo- or copolyesters, and partly aromatic copolyesters. Mixtures or blends of the abovementioned biodegradable polyesters are, of course, also suitable.

The biodegradable polyesters i) mentioned may comprise other biodegradable polymers of natural or synthetic origin as components of a blend or mixture. Examples of polymers of natural origin are shellac, starch, and cellulose. These may have been modified using physical and/or chemical methods. Preferred polymers of natural origin include starch, thermoplastically processable starch, and starch compounds, such as starch ethers. The ratio by weight of biodegradable polyesters i) to other biodegradable components of a blend or mixture, e.g. starch, can generally be freely selected within a wide range, for example in the range from 1.2:1 to 0.8:1.2.

Polymeric reaction products of lactic acid may be used as biodegradable esters i) for producing the biodegradable polyester films of the invention. These are known per se or may be prepared by processes known per se. Besides polylactide, it is also possible to use copolymers based on lactic acid and on other monomers, or to use similarly based block copolymers. Linear polylactides are mostly used. However, it is also possible to use branched lactic acid polymers. Examples of branching agents which may be used are polyfunctional acids or alcohols. For example, use may be made of polylactides obtainable substantively from lactic acid or from its C₁-C₄-alkyl ester or from a mixture of these, and from at least one aliphatic C₄-C₁₀-dicarboxylic acid and from at least one C₃-C₁₀ alkanol having from three to five hydroxyl groups.

Other examples of biodegradable polyesters i) from which the biodegradable polyester films are available are aliphatic polyesters. These include homopolymers of aliphatic hydroxycarboxylic acids or lactones, and also copolymers or block copolymers of different hydroxycarboxylic acids or lactones, and mixtures of these. Besides these, diols and/or isocyanates may be present as structural units in these aliphatic polyesters. The aliphatic polyesters may also contain structural units which derive from trifunctional or polyfunctional compounds, such as epoxides, acids or triols. The latter structural units may be present singly in the aliphatic polyesters, or there may be two or more thereof, or else they may be present together with the diols and/or isocyanates.

Processes for preparing aliphatic polyesters are known to the skilled worker. The aliphatic polyesters generally have molar masses (Mₙ) in the range from 8 000 to 100 000 g/mol.

Particularly preferred aliphatic polyesters include polycaprolactone.

Other particularly preferred aliphatic polyesters are poly-3-hydroxybutanoic esters and copolymers of 3-hydroxybutanoic acid, or mixtures thereof with 4-hydroxybutanoic acid and with 3-hydroxyvaleric acid, in particular with a proportion by weight of up to 30% by weight, preferably up to 20% by weight, of the last named acid. Suitable polymers of this type also include those with R-stereospecific configuration, such as those disclosed in WO 96/09402. Polyhydroxybutanoic esters and copolymers of these can be prepared microbially. Preparation processes from various bacteria and fungi can be found in Nachr. Chem. Tech. Lab. 39, 1112-1124 (1991), for example, and a process for preparing stereospecific polymers is disclosed in WO 96/09402.

Use may moreover also be made of block copolymers made from the abovementioned hydroxycarboxylic acids or lactones, or from their mixtures, oligomers or polymers.

Other aliphatic polyesters are those whose structure contains aliphatic or cycloaliphatic dicarboxylic acids or mixtures of these, and aliphatic or cycloaliphatic diols, or mixtures of these. According to the invention use may be made either of random copolymers or of block copolymers.

The aliphatic dicarboxylic acids suitable according to the invention generally have from 2 to 10 carbon atoms, preferably from 4 to 6 carbon atoms. They may be either linear or branched The cycloaliphatic dicarboxylic acids which can be used for the purposes of the present invention are generally those having from 7 to 10 carbon atoms, and in particular those having 8 carbon atoms. However, in principle it is also possible to use dicarboxylic acids having a larger number of carbon atoms, for example those having up to 30 carbon atoms. Examples which may be mentioned are: malonic acid, succinic acid, glutaric acid, 2-methylglutaric acid, 3-methylglutaric acid, adipic acid, pimelic acid, azelaic acid, sebacic acid, fumaric acid, 2,2-dimethylglutaric acid, suberic acid, 1,3-cyclopentanedicarboxylic acid, 1,4-cyclohexanedicarboxylic acid, 1,3-cyclohexanedicarboxylic acid, diglycolic acid, itaconic acid, maleic acid, and 2,5-norbornanedicarboxylic acid, and among these preference is given to adipic acid.

Particular ester-forming derivatives of the abovementioned aliphatic or cycloaliphatic dicarboxylic acids which may likewise be used are the di-C₁-C₆-alkyl esters, such as the dimethyl, diethyl, di-n-propyl, diisopropyl, di-n-butyl, diisobutyl, di-t-butyl, di-n-pentyl, diisopentyl or di-n-hexyl esters. It is also possible to use anhydrides of the dicarboxylic acids.

The dicarboxylic acids here or their ester-forming derivatives may be used individually or as a mixture made from two or more of these.

Examples of aliphatic polyesters which may be used are aliphatic copolyesters as described in WO 94/14870, in particular aliphatic copolyesters made from succinic acid, its diesters, or mixtures of these with other aliphatic acids and, respectively, diesters, for example glutaric acid and butanediol, or mixtures of this diol with ethylene glycol, propanediol or hexanediol, or mixtures of these.

Aliphatic polyesters of this type generally have molar masses (Mₙ) in the range from 8 000 to 100 000 g/mol.

The aliphatic polyesters may also be random or block copolyesters which contain other monomers. The proportion of the other monomers is generally up to 10% by weight. Preferred comonomers are hydroxycarboxylic acids or lactones, or mixtures of these.

In preparing the aliphatic polyesters it is, of course, also possible to use mixtures made from two or more comonomers and/or from other structural units, such as epoxides or polyfunctional aliphatic or aromatic acids, or polyfunctional alcohols.

The biodegradable polyester films of to the invention film may also be based on partly aromatic polyesters as component i). For the purposes of the present invention, these include polyester derivatives, such as polyetheresters, polyesteramides, and polyetheresteramides. Suitable biodegradable partly aromatic polyesters include linear polyesters which have not been chain-extended (WO 92/09654). Preference is given to chain-extended and/or branched partly aromatic polyesters. The latter are disclosed in the publications mentioned at the outset, WO 96/15173 to 15176, 21689 to 21692, 25446, 25448 or WO 98/12242, which are expressly incorporated herein by way of reference. Mixtures of various partly aromatic polyesters may also be used, as may blends of partly aromatic polyesters with starch or with modified starch, or with cellulose esters, or polylactide.

Particularly preferred partly aromatic polyesters include polyesters in which the substantive components present comprise

A) an acid component made from

a1) from 30 to 95 mol % of at least one aliphatic, or at least one cycloaliphatic, dicarboxylic acid, or ester-forming derivatives thereof, or mixtures of these

a2) from 5 to 70 mol % of at least one aromatic dicarboxylic acid, or an ester-forming derivative thereof, or a mixture of these, and

a3) from 0 to 5 mol % of a compound containing sulfonate groups,

B) at least one diol component selected from the group consisting of C₂-C₁₂-alkanediols and C₅-C₁₀-cycloalkanediols and mixtures of these

and, if desired, also one or more components selected from

C) at least one component selected from

c1) dihydroxy compounds containing ether functions and having the formula I

HO—[(CH₂)ₙ—O]ₘ—H (I)

where n is 2, 3 or 4, and m is an integer from 2 to 250

c2) hydroxycarboxylic acids of the formula IIa or IIb

HO—[—C(O)-G-O—]ₚH (IIa)

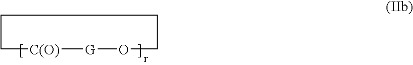

where p is an integer from 1 to 1500, and r is an integer from 1 to 4, and G is a radical selected from the group consisting of phenylene, —(CH₂)_{q}—, where q is an integer from 1 to 5, —C(R)H— and —C(R)HCH₂, where R is methyl or ethyl

c3) amino-C₂-C₁₂ alkanols and amino-C₅-C₁₀ cycloalkanols or mixtures of these

c4) diamino-C₁-C₈ alkanes

c5) 2,2′-bisoxazolines of the formula III

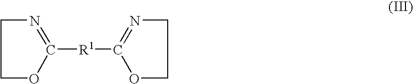

where R¹ is a single bond, (CH₂)_{z} alkylene, where z=2, 3 or 4, or phenylene, and

c6) aminocarboxylic acids selected from the group consisting of the naturally occurring amino acids, polyamides with molar masses of not more than 18000 g/mol obtainable by polycondensing a dicarboxylic acid having from 4 to 6 carbon atoms with a diamine having from 4 to 10 carbon atoms, and compounds of the formulae IVa and IVb

HO—[—C(O)-T-N(H)—]ₛH (IVa)

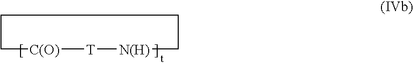

where s is an integer from 1 to 1500 and t is an integer from 1 to 4, and T is a radical selected from the group consisting of phenylene, —(CH₂)ₙ—, where n is an integer from 1 to 12, —C(R²)ₙ— and —C(R²)HCH₂, where R² is methyl or ethyl,

and polyoxazolines having the repeat unit V

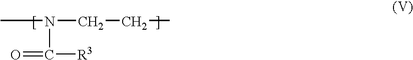

where R³ is hydrogen, C₁-C₆-alkyl, C₅-C₈-cycloalkyl, or phenyl, either unsubstituted or having up to three C₁-C₄-alkyl substituents, or is tetrahydrofuryl,

or a mixture made from c1 to c6 and

D) a component selected from

d1) compounds having at least three groups capable of ester formation,

d2) isocyanates, and

d3) divinyl ethers

or a mixture made from d1) to d3).

The acid component A of the preferred partly aromatic polyesters comprises from 30 to 70 mol %, in particular from 40 to 60 mol % of al and from 30 to 70 mol %, in particular from 40 to 60 mol % of a2.

Aliphatic or cycloaliphatic acids and their derivatives al which may be used are those mentioned above. It is particularly preferable to use adipic acid or sebacic acid or ester-forming derivatives of each, or mixtures of these. It is particularly preferable to use adipic acid or its ester-forming derivatives, for example alkylesters thereof, or mixtures thereof.

Aromatic dicarboxylic acids a2 which may be mentioned are generally those having from 8 to 12 carbon atoms, and preferably those having 8 carbon atoms. Examples which may be mentioned are terephthalic acid, isophthalic acid, 2,6-naphthoic acid and 1,5-naphthoic acid, and also ester-forming derivatives thereof. Particular mention should be made here of the di-C₁-C₆-alkyl esters, e.g. the dimethyl, diethyl, di-n-propyl, diisopropyl, di-n-butyl, diisobutyl, di-t-butyl, di-n-pentyl, diisopentyl and di-n-hexyl esters. The anhydrides of the dicarboxylic acids a2 are also suitable ester-forming derivatives.

However, it is also possible in principle to use aromatic dicarboxylic acids a2 having a larger number of carbon atoms, for example up to 20 carbon atoms.

The aromatic dicarboxylic acids or ester-forming derivatives of these a2 may be used individually or as a mixture made from two or more of these. Particular preference is given to using terephthalic acid or its ester-forming derivatives, such as dimethyl terephthalate.

The compound used containing sulfonate groups usually comprises the alkali metal salt or alkaline earth metal salt of a dicarboxylic acid containing sulfonate groups, or comprises ester-forming derivatives thereof, preferably alkali metal salts of 5-sulfoisophthalic acid, or mixtures of these, particularly preferably the sodium salt.

In one of the preferred embodiments, the acid component A comprises from 40 to 60 mol % of al, from 40 to 60 mol % of a2, and from 0 to 2 mol % of a3. In another preferred embodiment, the acid component A comprises from 40 to 59.9 mol % of al, from 40 to 59.9 mol % of a2, and from 0.1 to 1 mol % of a3, in particular from 40 to 59.8 mol % of al, from 40 to 59.8 mol % of a2, and from 0.2 to 0.5 mol % of a3.

The diols B are generally selected from among branched or linear alkanediols having from 2 to 12 carbon atoms, preferably from 4 to 6 carbon atoms, or among cycloalkanediols having from 5 to 10 carbon atoms.

Examples of suitable alkanediols are ethylene glycol, 1,2-propanediol, 1,3-propanediol, 1,2-butanediol, 1,4-butanediol, 1,5-pentanediol, 2,4-dimethyl-2-ethylhexane-1,3-diol, 2,2-dimethyl-1,3-propanediol, 2-ethyl-2-butyl-1,3-propanediol, 2-ethyl-2-isobutyl-1,3-propanediol, 2,2,4-trimethyl-1,6-hexanediol, in particular ethylene glycol, 1,3-propanediol, 1,4-butanediol, and 2,2-dimethyl-1,3-propanediol (neopentyl glycol); cyclopentanediol, 1,4-cyclohexanediol, 1,2-cyclohexanedimethanol, 1,3-cyclohexanedimethanol, 1,4-cyclohexanedimethanol and 2,2,4,4-tetramethyl-1,3-cyclobutanediol. It is also possible to use mixtures of various alkanediols.

Depending on whether an excess of acid end groups or of OH end groups is desired, either an excess of component A or an excess of component B may be used. In one preferred embodiment, the molar ratio of component A to component B may be in the range from 0.4:1 to 1.5:1, preferably in the range from 0.6:1 to 1.1:1.

Besides components A and B, the polyesters on which the biodegradable polyester films of to the invention are based may comprise other components. Preferred dihydroxy compounds cl used are diethylene glycol, triethylene glycol, polyethylene glycol, polypropylene glycol and polytetrahydrofuran (poly THF), particularly preferably diethylene glycol, triethylene glycol and polyethylene glycol, and it is also possible here to use mixtures of these or compounds which have various variables n (see formula I), for example polyethylene glycol which contains propylene units (n=3) and can be obtained, for example, by using methods known per se to polymerize firstly ethylene oxide and then propylene oxide, and it is particularly preferable here to use a polymer based on polyethylene glycol and having various variables n, with a predominance of units formed from ethylene oxide. The molar mass (Mₙ) of the polyethylene glycol is generally selected to be in the range from 250 to 8000 g/mol, preferably from 600 to 3000 g/mol.

In one of the preferred embodiments the partly aromatic polyesters may be prepared by using, for example, from 15 to 98 mol %, preferably from 60 to 99.5 mol %, of the diols B, and from 0.2 to 85 mol %, preferably from 0.5 to 30 mol %, of the dihydroxy compounds c1, based on the molar amount of B and c1.

In one preferred embodiment, the hydroxycarboxylic acid c2) used comprises: glycolic acid, D-, L- or D,L-lactic acid, 6-hydroxyhexanoic acid, cyclic derivatives thereof, such as glycolide (1,4-dioxane-2,5-dione), D- or L-dilactide (3,6-dimethyl-1,4-dioxane-2,5-dione), or p-hydroxybenzoic acid, or else their oligomers or polymers, such as 3-polyhydroxybutyric acid, polyhydroxyvaleric acid, or polylactide (obtainable as EcoPLA® (Cargill), for example), or else a mixture made from 3-polyhydroxybutyric acid and polyhydroxyvaleric acid (the latter being obtainable as Biopol® from Zeneca), the low-molecular-weight and cyclic derivatives thereof being particularly preferred for preparing partly aromatic polyesters.

Examples of the amounts of the hydroxycarboxylic acids used are from 0.01 to 50% by weight, preferably from 0.1 to 40% by weight, based on the amount of A and B.

The amino-C₂-C₁₂ alkanol or amino-C₅-C₁₀ cycloalkanol used (component c3), which for the purposes of the present invention also include 4-aminomethylcyclohexylmethanol, preferably comprise amino-C₂-C₆ alkanols, such as 2-aminoethanol, 3-aminopropanol, 4-aminobutanol, 5-aminopentanol and 6-aminohexanol, and also amino-C₅-C₆ cycloalkanols, such as aminocyclopentanol and aminocyclohexanol, or mixtures of these.

The diamino-C₁-C₈ alkanes (component c4) used are preferably diamino-C₄-C₆ alkanes, such as 1,4-diaminobutane, 1,5-diaminopentane and 1,6-diaminohexane (hexamethylenediamine, HMD).

In one preferred embodiment, the partly aromatic polyesters may be prepared using from 0.5 to 99.5 mol %, preferably from 70 to 98.0 mol %, of the diol component B, from 0.5 to 99.5 mol %, preferably from 0.5 to 50 mol %, of c3, and from 0 to 50 mol %, preferably from 0 to 35 mol %, of c4, based on the molar amount of B, c3 and c4.

The 2,2′-bisoxazolines c5 of the formula III are generally obtainable via the process in Angew. Chem. Int. Ed., Vol. 11 (1972), pp. 287-288. Particularly preferred bisoxazolines are those where R¹ is a single bond, a (CH₂)_{q} alkylene group, where q=2, 3 or 4, for example methylene, ethane-1,2-diyl, propane-1,3-diyl or propane-1,2-diyl, or is a phenylene group. Particularly preferred bisoxazolines which may be mentioned are 2,2′-bis(2-oxazoline), bis(2-oxazolinyl)methane, 1,2-bis(2-oxazolinyl)ethane, 1,3-bis(2-oxazolinyl)propane and 1,4-bis(2-oxazolinyl)butane, in particular 1,4-bis(2-oxazolinyl)benzene, 1,2-bis(2-oxazolinyl)benzene and 1,3-bis(2-oxazolinyl)benzene.

The partly aromatic polyesters may be prepared using, for example, from 70 to 98 mol % of B, from 1 to 30 mol % of c3, and from 0.5 to 30 mol % of c4, and from 0.5 to 30 mol % of c5, based in each case on the total of the molar amounts of components B, c3, c4 and c5. In another preferred embodiment, use may be made of from 0.1 to 5% by weight, preferably from 0.2 to 4% by weight, of c5, based on the total weight of A and B.

Naturally occurring aminocarboxylic acids may be used as component c6. These include valine, leucine, isoleucine, threonine, methionine, phenylalanine, tryptophane, lysine, alanine, arginine, aspartic acid, cysteine, glutamic acid, glycine, histidine, proline, serine, tyrosine, asparagine and glutamine.

Preferred aminocarboxylic acids of the formulae IVa and IVb are those where s is an integer from 1 to 1000 and t is an integer from 1 to 4, preferably 1 or 2, and T has been selected from the group consisting of phenylene and —(CH₂)ₙ—, where n is 1, 5 or 12.

c6 may moreover be a polyoxazoline of the formula V, but may also be a mixture of various aminocarboxylic acids and/or polyoxazolines.

In one preferred embodiment, use may be made of from 0.01 to 50% by weight, preferably from 0.1 to 40% by weight, of c6, based on the total amount of components A and B.

Other components which may be used, if desired, for preparing the partly aromatic polyesters include compounds d1 which contain at least three groups capable of ester formation.

The compounds d1 preferably contain from three to ten functional groups capable of developing ester bonds. Particularly preferred compounds d1 have from three to six functional groups of this type in the molecule, in particular from three to six hydroxyl groups and/or carboxyl groups. Examples which may be mentioned are:

tartaric acid, citric acid, malic acid;

trimethylolpropane, trimethylolethane;

pentaerythritol;

polyethertriols;

glycerol;

trimesic acid;

trimellitic acid, trimellitic anhydride;

pyromellitic acid, pyromellitic anhydride, and hydroxyisophthalic acid

The amounts generally used of the compounds d1 are from 0.01 to 15 mol%, preferably from 0.05 to 10 mol%, particularly preferably from 0.1 to 4 mol%, based on component A.

The component d2 used is isocyanate or a mixture of various isocyanates. For example, use may be made of aromatic or aliphatic diisocyanates. However, it is also possible to use isocyanates of higher functionality.

For the purposes of the present invention, aromatic diisocyanates d2 are especially

tolylene 2,4-diisocyanate, tolylene 2,6-diisocyanate, diphenylmethane 2,2′-diisocyanate, diphenylmethane 2,4′-diisocyanate, diphenylmethane 4,4′-diisocyanate, naphthylene 1,5-diisocyanate or xylylene diisocyanate.

Among these, particular preference is given to diphenylmethane 2,2′-, 2,4′-, and 4,4′-diisocyante as component d2. Th diisocyanates are generally used as a mixture.

Another isocyanate d2 which may be used is the three-ringed isocyanate tri(4-isocyanatophenyl)methane. Aromatic diisocyanates having a multiplicity of rings are produced, for example, during the preparation of diisocyanates having one or two rings.

Component d2 may also contain subordinate amounts, e.g. up to 5% by weight, based on the total weight of component d2, of uretdione groups, for example for capping the isocyanate groups.

For the purposes of the present invention, aliphatic diisocyanates d2 are especially linear or branched alkylene diisocyanates or cycloalkylene diisocyanates having from 2 to 20 carbon atoms, preferably from 3 to 12 carbon atoms, e.g. hexamethylene 1,6-diisocyanate, isophorone dissocyanate, or methylenebis (4-isocyanatocyclohexane). Particularly preferred aliphatic diisocyanates d2 are hexamethylene 1,6-diisocyanate and isophorone diisocyanate.

Preferred isocyanurates include the aliphatic isocyanurates, for example isocyanurates which derive from alkylene diisocyanates or from cycloalkylene diisocyanates having from 2 to 20 carbon atoms, preferably from 3 to 12 carbon atoms, e.g. isophorone diisocyanate or methylenebis (4-isocyanatocyclohexane). These alkylene diisocyanates may be either linear or branched.

Particular preference is given to diisocyanurates based on n-hexamethylene diisocyanate, for example cyclic trimers, pentamers, or higher oligomers of n-hexamethylene diisocyanate.

The amount usually used for component d2 is from 0.01 to 5 mol %, preferably from 0.05 to 4 mol %, in particular from 0.1 to 4 mol %, based on the total of the molar amounts of A and B.

Divinyl ethers d3 which may be used are generally any of the customary and commercially available divinyl ethers. Preference is given to the use of 1,4-butanediol divinyl ethers, 1,6-hexanediol divinyl ethers or 1,4-cyclohexanedimethanol divinyl ethers, or mixtures of these.

The amounts preferably used of the divinyl ethers are from 0.01 to 5% by weight, in particular from 0.2 to 4% by weight, based on the total weight of A and B.

Examples of preferred partly aromatic polyesters are based on the following components

A, B, d1
A, B, d2
A, B, d1, d2
A, B, d3
A, B, c1
A, B, c1, d3
A, B, c3, c4
A, B, c3, c4, c5
A, B, d1, c3, c5
A, B, c3, d3
A, B, c3, d1
A, B, c1, c3, d3
A, B, c2

Among these, particular preference is given to partly aromatic polyesters based on A, B and d1, or A, B and d2, or A, B, d1 and d2. In another preferred embodiment, the partly aromatic polyesters are based on A, B, c3, c4 and c5, or A, B, d1, c3 and c5.

The preparation of the partly aromatic polyesters is known per se, or can take place by methods known per se.

The characteristic features of the preferred partly aromatic polyesters are a molar mass (Mₙ) in the range from 8000 to 100,000 g/mol, in particular in the range from 9000 to 75,000 g/mol; with preference in the range from 10,000 to 50,000 g/mol, and a melting point in the range from 60 to 170° C., preferably in the range from 80 to 150° C.

The aliphatic and/or partly aromatic polyesters mentioned may have hydroxyl end groups and/or carboxyl end groups, in any desired ratio. The aliphatic and/or partly aromatic polyesters mentioned may also have been end-group-modified. For example, OH end groups may have been acid-modified by reaction with phthalic acid, phthalic anhydride, trimellitic acid, trimellitic anhydride, pyromellitic acid, or pyromellitic anhydride.

Suitable components ii) of the polyester film are one or more compounds selected from

ii1) a surfactant or surfactant mixture, for example an anionic, cationic, amphoteric, or nonionic surfactant and

ii2) polyesters with a molar mass Mₙ in the range from 1000 to 7000 g/mol, in particular from 1200 to 6000 g/mol, preferably from 1400 to 5000 g/mol, very particularly preferably from 1600 to 4000 g/mol.

It is possible to use exclusively one or more compounds ii1) or exclusively one or more compounds ii2) as component ii), or to use a mixture made from one or more compounds of each of compounds ii1) and ii2).

Compounds preferably suitable as component ii) are those which are solid at room temperature.

Examples of cationic and anionic surfactants are described in “Encyclopedia of Polymer Science and Technology”, J. Wiley & Sons (1966), Volume 5, pp. 816-818, and in “Emulsion Polymerisation and Emulsion Polymers”, eds. P. Lovell and M. El-Asser, published by Wiley & Sons (1997), pp. 224-226. Examples of anionic surfactants are alkali metal salts of organic carboxylic acids having chain lengths of from 8 to 30 carbon atoms, preferably from 12 to 18 carbon atoms. These are generally called soaps. They are generally used in the form of sodium salts, potassium salts, or ammonium salts. Other anionic surfactants which may be used are alkyl sulfates and alkyl- or alkylarylsulfonates having from 8 to 30 carbon atoms, preferably from 12 to 18 carbon atoms. Particularly suitable compounds are alkali dodecyl sulfates, e.g. sodium dodecyl sulfate or potassium dodecyl sulfate, and alkali metal salts of C₁₂-C₁₆ paraffinsulfonic acids. Other suitable compounds are sodium dodecylbenzenesulfonate and the sodium salt of dioctyl sulfosuccinate.

Examples of suitable cation c surfactants are salts of amines or of diamines, quaternary ammonium salts, e.g. hexadecyltrimethylammonium bromide, and also salts of long-chain substituted cyclic amines, such as pyridine, morpholine, piperidine. Particular compounds used are quaternary ammonium salts of trialkylamines, e.g. hexadecyltrimethylammonium bromide. The alkyl radicals in these preferably have from 1 to 20 carbon atoms.

According to the invention, nonionic surfactants may in particular be used as component ii1). Examples of nonionic surfactants are described in CD Römpp Chemie Lexikon—Version 1.0, Stuttgart/New York: Georg Thieme Verlag 1995, keyword “Nichtionische Tenside” [Nonionic surfactants].

Examples of suitable nonionic surfactants are polyethylene-oxide- or polypropylene-oxide-based substances, such as Pluronic® or Tetronic® from BASF Aktiengesellschaft. Polyalkylene glycols suitable as nonionic surfactants ii1) generally have a molar mass Mₙ in the range from 1000 to 15,000 g/mol, preferably from 2000 to 13,000 g/mol, particularly preferably from 4000 to 11,000 g/mol. Component ii) is preferably polyethylene glycol.

The polyalkylene glycols are known per se or may be prepared by processes known per se, for example by anionic polymerization using alkali metal hydroxide catalysts, such as sodium hydroxide or potassium hydroxide, or using alkali metal alkoxides, such as sodium methoxide, sodium ethoxide, potassium ethoxide or potassium isopropoxide, and with addition of at least one starter molecule which contains from 2 to 8 reactive hydrogen atoms, preferably from 2 to 6 reactive hydrogen atoms, or by cationic polymerization using Lewis acid catalysts, such as antimony pentachloride, boron fluoride etherate, or bleaching earth, the starting materials being one or more alkylene oxides having 2 to 4 carbon atoms in the alkylene radical.

Examples of suitable alkylene oxides are tetrahydrofuran, butylene 1,2- or 2,3-oxide, styrene oxide, and preferably ethylene oxide and/or propylene 1,2-oxide. The alkylene oxides may be used individually, alternating one after the other, or as a mixture. Examples of starter molecules which may be used are: water, organic dicarboxylic acids, such as succinic acid, adipic acid, phthalic acid, or terephthalic acid, aliphatic or aromatic, unsubstituted or N-mono-, or N,N- or N,N′-dialkyl-substituted diamines having from 1 to 4 carbon atoms in the alkyl radical, such as unsubstituted or mono- or dialkyl-substituted ethylenediamine, diethylenetriamine, triethylenetetramine, 1,3-propylenediamine, 1,3- or 1,4-butylenediamine, or 1,2-, 1,3-, 1,4-, 1,5- or 1,6-hexamethylenediamine.

Other starter molecules which may be used are: alkanolamines, e.g. ethanolamine, N-methyl- or N-ethylethanolamine, dialkanolamines, e.g. diethanolamine, and N-methyl- and N-ethyldiethanolamine, and trialkanolamines, e.g. triethanolamine, and ammonia. It is preferable to use polyhydric alcohols, in particular di- or trihydric alcohols or alcohols with functionality higher than three, for example ethanediol, 1,2-propanediol, 1,3-propanediol, diethylene glycol, dipropylene glycol, 1,4-butanediol, 1,6-hexanediol, glycerol, trimethylolpropane, pentaerythritol, sucrose, and sorbitol.

Other suitable components ii1) are esterified polyalkylene glycols, such as the mono-, di-, tri- or polyesters of the polyalkylene glycols mentioned which can be prepared by reacting the terminal OH groups of the polyalkylene glycols ii1) mentioned with the acids described above as components al) or a2), preferably adipic acid or terephthalic acid, in a manner known per se. Polyethylene glycol adipate or polyethylene glycol terephthalate is preferred as component ii1).

Particularly suitable nonionic surfactants are substances prepared by alkoxylating compounds having active hydrogen atoms, for example adducts of ethylene oxide onto fatty alcohols, oxo alcohols, or alkylphenols. Ethylene oxide or propylene 1,2-oxide are preferably used for the alkoxylation.

Other preferred nonionic surfactants are alkoxylated or non-alkoxylated sugar esters or sugar ethers.

Sugar ethers are alkyl glycosides obtained by reacting fatty alcohols with sugars, and sugar esters are obtained by reacting sugars with fatty acids. The sugars, fatty alcohols, and fatty acids needed to prepare the substances mentioned are known to the skilled worker.

Examples of suitable sugars are described in Beyer/Walter, Lehrbuch der organischen Chemie [Textbook of organic chemistry], S. Hirzel Verlag Stuttgart, 19th edition, 1981, pp. 392-425. Particularly suitable sugars are D-sorbitol and the sorbitans obtained by dehydrating D-sorbitol.

Suitable fatty acids are saturated or mono- or polyunsaturated unbranched or branched carboxylic acids having from 6 to 26 carbon atoms, preferably from 8 to 22 carbon atoms, particularly preferably from 10 to 20 carbon atoms, for example as mentioned in CD Römpp Chemie Lexikon—Version 1.0, Stuttgart/New York: Georg Thieme Verlag 1995, keyword “Fettsäuren” [Fatty acids). Preferred fatty acids are lauric acid, palmitic acid, stearic acid, and oleic acid.

The carbon skeleton of suitable fatty alcohols is identical with that of the compounds described as suitable fatty acids.

Sugar ethers, sugar esters, and the process for their preparation are known to the skilled worker. Preferred sugar ethers are prepared by known processes, by reacting the sugars mentioned with the fatty alcohols mentioned. Preferred sugar esters are prepared by known processes, by reacting the sugars mentioned with the fatty acids mentioned. Preferred sugar esters are the mono-, di- and triesters of the sorbitans with fatty acids, in particular sorbitan monolaurate, sorbitan dilaurate, sorbitan trilaurate, sorbitan monooleate, sorbitan dioleate, sorbitan trioleate, sorbitan monopalmitate, sorbitan dipalmitate, sorbitan tripalmitate, sorbitan monostearate, sorbitan distearate, sorbitan tristearate, and sorbitan sesquioleate, a mixture of sorbitan mono- and dioleates.

Very particularly suitable components ii1) are alkoxylated sugar ethers and sugar esters obtained by alkoxylating the sugar ethers and sugar esters mentioned. Preferred alkoxylating agents are ethylene oxide and propylene 1,2-oxide. The degree of alkoxylation is generally from 1 to 20, preferably from 2 to 10, particularly preferably from 2 to 6. Particularly preferred alkoxylated sugar esters are polysorbates obtained by ethoxylating the sorbitan ester described above, for example as described in CD Römpp Chemie Lexikon—Version 1.0, Stuttgart/New York: Georg Thieme Verlag 1995, keyword “Polysorbate” [Polysorbates]. Particularly preferred polysorbates are polyethoxysorbitan laurate, stearate, palmitate, tristearate, oleate, trioleate, in particular polyethoxysorbitan stearate, which is obtainable, for example, as Tween®60 from ICI America Inc. (described by way of example in CD Römpp Chemie Lexikon—Version 1.0, Stuttgart/New York: Georg Thieme Verlag 1995, keyword “Tween®”).

Suitable polyesters ii2) are those mentioned in the description of the polyesters i) with the exception that the molar mass Mₙ of the polyesters ii2) is in the range from 1000 to 7000 g/mol, in particular from 1200 to 6000 g/mol, preferably from 1400 to 5000 g/mol, very particularly preferably from 1600 to 4000 g/mol.

The compounds ii2) which may be used are, of course, independent of the compounds i).

Since the molar masses Mₙ of ii2) and i) are averages of a distribution function, it is fully possible for individual polymer molecules of ii2), for example, to have a higher molar mass than individual polymer molecules i). However, according to the invention the polymer molecules of i) have on average a higher molar mass than those of ii2).

Particularly suitable polyesters ii2) are aliphatic or partly aromatic polyesters, in particular biodegradable aliphatic or partly aromatic polyesters.

Preference is given to biodegradable partly aromatic polyesters ii2). Particular preference is given to biodegradable partly aromatic branched polyesters whose OH end groups have been acid-modified, for example by reaction with phthalic acid, phthalic anhydride, trimellitic acid, trimellitic anhydride, pyromellitic acid, or pyromellitic anhydride.

In another particularly preferred embodiment, aliphatic polyesters composed of adipic acid and propylene 1,2-glycol are suitable as component ii2), for example Palamoll® 636 from BASF Aktiengesellschaft, a polyester with a molar mass Mₙ of 2400 g/mol.

The polyester films of the invention usually comprise from 70 to 99.9% by weight, preferably from 85 to 99.9% by weight, particularly preferably from 90 to 99.8% by weight, in particular from 95 to 99.7% by weight of component i), and from 0.1 to 30,0% by weight, preferably from 0,1 to 15,0% by weight, particularly preferably from 0,2 to 10% by weight, in particular from 0.3 to 5% by weight of component ii), where the percentages by weight of components i) to ii) give 100% in total.

If the component ii) used is exclusively compounds of component ii1), the polyester films of the invention usually comprise from 95 to 99.9% by weight, preferably from 97 to 99.9% by weight, particularly preferably from 98 to 99.8% by weight, of component i), and from 0.1 to 5% by weight, preferably from 0,1 to 3% by weight, particularly preferably from 0,2 to 2% by weight, of component ii), where the percentages by weight of component i) to ii) give 100% in total.

The compounds of components ii) may firstly act as what are known as nucleating agents in the polyesters i), i.e. during cooling they cause increased formation of crystal nuclei and reduce the crystallization time in a polyester melt of this type when compared with polyesters without component ii).

The presence of component ii) in the polyester films of the invention can moreover lead to improved adhesion, i.e. to improved tendency to adhere both to other materials and to the material of the polyester films of the invention themselves, or lead to improved antifogging properties, i.e. reduced deposition of small droplets through the condensation of steam onto the polyester film (instead of which an antifogging additive causes the formation of relatively large flat drops or films of water, resulting in a less marked reduction in the transparency, for example that of a film), or lead to an improvement in more than one of these properties.

The polyester films and/or the polyesters i) may comprise additives, which may be incorporated at any stage of the polymerization procedure or subsequently, for example into a melt of the polyesters, or may be incorporated when component ii) is being incorporated. Examples of these are stabilizers, neutralizing agents, lubricants, release agents, antiblocking agents, nucleating agents not falling within the definition of ii), dyes, and fillers.

Based on the polyesters i), use may be made of from 0 to 80% by weight of additives. Examples of suitable additives are fillers, stabilizers, nucleating agents not falling within the definition of ii), e.g. talc, lubricants, and mold-release agents. Additives of this type are described in detail in Kunststoff-Handbuch, Vol. 3/1, Carl Hanser Verlag, Munich, 1992, pp. 24-28, for example.

Examples of fillers are particulate substances, such as calcium carbonate, clay minerals, calcium sulfate, barium sulfate, titanium dioxide, carbon black, lignin powder, iron oxide, which may also act as colorants, and also fiber materials, e.g. cellulose fibers, sisal fibers, and hemp fibers. The proportion of fillers is generally not above 40% by weight, based on the total weight of the film material, in particular not more than 20% by weight.

Examples of stabilizers are tocopherol (vitamin E), organic phosphorus compounds, mono-, di- and polyphenols, hydroquinones, diarylamines, thioethers, melamine, and urea. Examples of antiblocking agents which may be used are talc, chalk, mica, and silicon oxides. Lubricants and mold-release agents are generally substances based on hydrocarbons, on fatty alcohols, on higher carboxylic acids, on metal salts of higher carboxylic acids, such as calcium stearate or zinc stearate, or are fatty amides, such as erucamide, or types of wax, e.g. paraffin waxes, beeswax, montan waxes, and the like. Preferred release agents are erucamide and/or types of wax, and combinations of these two types of release agent are particularly preferred. Preferred types of wax are beeswax and ester waxes, in particular glycerol monostearate. It is particularly preferable for the polyesters i) to be used for producing the polyester films of the invention to have been provided with from 0.05 to 2.0% by weight of erucamide, or from 0.1 to 2.0% by weight of types of wax, based in each case on the plastics content of the polyester films. It is very particularly preferable for the polyesters i) used for producing the polyester films of the invention to have been provided with from 0.05 to 0.5% by weight of erucamide and from 0.1 to 1.0% by weight of types of wax, in particular glycerol monostearate, based in each case on the plastics content of the polyester films.

Known processes with the aid of known mixing equipment may be used to introduce component ii) into the polyester i) (see, for example, Saechtling, Kunststoff-Taschenbuch, Hanser Verlag, Munich, Vienna, Edition 26, 1995, pp. 191-246). For example, components ii) may be mixed into component i) with the aid of a screw machinery, e.g. an extruder, in a separate step prior to the actual production of a film, or else mixed directly into the melt from which the film is to be produced, either in pure form or in what is known as a masterbatch.

These masterbatches are generally specific molding compositions in which the additives or added materials needed, for example component ii), have been embedded within a matrix made from thermoplastic polymer, for example, such as component i), but the additive content is markedly higher than that used in conventional molding compositions provided with additives, for example in the range from 10 to 70% by weight. Addition of appropriate amounts of masterbatch to a thermoplastic, for example one without additives, permits production of molding compositions with conventional additive contents.

The polyester films of the invention may be produced in a manner similar to the production of known polymer films, generally by processing one of the abovementioned polyesters i), which is generally thermoplastic, by known processes to give a film. The processing of thermoplastic polyesters to give films generally takes place by extrusion or coextrusion, particularly blown film extrusion, chill roll extrusions, or extrusion coating or coextrusion coating.

The thickness of any particular film depends on its intended use and, respectively, on the nature of the polyester film. It is usually in the range from 8 to 1000 μm, and in particular in the range from 10 to 100 μm. The preferred thickness for films for retaining freshness, e.g. for foods, is from 10 to 30 μm, in particular from 10 to 22 μm.

The film material of the invention may also be combined with stiff substrates, e.g. with paper/card, films made from polylactides, polyesteramides, or nonwovens made from biodegradable materials, in order to give the polyester film of the invention increased stiffness. The polyester films of the invention may, of course, be colored, e.g. via incorporation of appropriate dyes or pigments into the plastics matrix, or by printing with suitable colorants.

The polyester films of the invention may be oriented, during or after their production. The stretching procedure can give, for example, biodegradable polyester films with an increased service life, i.e. low susceptibility to breakdown during use, but with identical biodegradability. The polyester films of the invention may be stretched monoaxially or else biaxially. The longitudinal stretching ratio is generally at least 1:2.0. It is mostly not above 1:10. The stretching ratio is preferably in the range from 1:3 to 1:6. The transverse stretching ratio is similarly generally from 1:2.5 to 1:10, preferably from 1:3 to 1:6.

Processes for orienting films are known to the skilled worker (see U.S. Pat. No. 3,456,044 for example). The polyester films of the invention are generally oriented above the glass transition temperature and, respectively, below the crystalline melting points of the polymers on which they are based. In one preferred embodiment, orientation is carried out at from 0 to 100° C., in particular from 20 to 60° C. The stretching procedure may take place in a single step or in more than one step.

One way of achieving this is to guide solidified polyester films of the invention through rollers rotating at different rates. In the case of biaxially oriented polyester films of the invention, the width of the polyester film may be stretched simultaneously, or in two steps, by way of devices known as clip chains applied laterally. In the case of blown films, the biaxial orientation generally takes place simultaneously in the extrusion process, by way of the air enclosed within the bubble. The blow-up ratio provides information on the orientation of the film in the direction of its circumference, if other parameters remain constant. The ratio of take-off speeds between the final pair of rollers and the first pair indicates the degree of longitudinal orientation. The degree of orientation of the film can be varied by way of the cooling air temperature and the way in which the cooling air is conducted. The degree of orientation generally rises as the cooling air temperature falls as long as there is a sufficiently high flow rate of cooling air and the way in which the cooling air is conducted is adequate.

In the case of biaxially oriented blown films, an example of the pressures applied into the bubble are from 1 to 3 bar, the pressure depending on the desired degree of expansion of the film.

However, in order to achieve good stretchability and reproducibly accurate calibration (gage accuracy) in biaxially oriented polyester films, it is advantageous to cool the polyester films after discharge of the melt from the extruder die in a first stage on chill rolls with an antiadhesive coating (e.g. polytetrafluoroethylene PTFE, or titanium nitride) to 0-25° C., preferably 3-10° C., and then, in a second stage, to heat the films to 30-95° C, preferably from 50-80° C., followed by stretching.

After the polyester films have been stretched they may be heat-set using heated rolls or using hot air (from about 75 to 150° C., preferably from 100 to 120° C.). For this, the polyester films are passed, for example, by way of rollers through a closed container with a temperature-controlled flow of air or of steam. The residence time is usually from 1 to 20 s, preferably from 2 to 5 s.

Particularly for producing films for retaining freshness, the polyester films of the invention may be wound using surface winders suitable for flexible thin films, to give smooth, uniformly cylindrical rolls of film.

The polyester film of the invention is especially well suited to any application in which increased transparency, improved adhesion with respect to other materials and with respect to the material of the polyester films of the invention, and/or improved antifogging properties, are of particular importance.

Examples of uses where this is the case are packaging film or film for retaining freshness, in particular for the packaging of foods or drinks, such as meat, fish, seafood, dairy products, egg products, vegetables, salads, fruit, nuts, berries, or mushrooms.

The polyester films of the invention may be the sole packaging material, or be used together with other materials, such as paper, card, and/or substrates made from the foamed products known as “trays”, e.g. those made of polystyrene, starch, starch blends or pulp. If the polyester films of the invention are used together with other materials, these other materials are preferably biodegradable.

The polyester film of the invention provides films which have increased transparency, increased adhesion, and/or improved antifogging properties.

### EXAMPLES

Performance Tests:

The molecular weight Mₙ of the polymers was determined as follows: 15 mg of the polymers were dissolved in 10 ml of hexafluoroisopropanol (HFIP). 125 μl of each of these solutions were analyzed by gel permeation chromatography (GPC). The tests were carried out at room temperature. HFIP+0.05% by weight of potassium trifluoroacetate was used for elution. The elution rate was 0.5 ml/min. The column combination used here was as follows (all columns produced by Showa Denko Ltd., Japan): Shodex® HFIP-800P (diameter 8 mm, length 5 cm), Shodex® HFIP-803 (diameter 8 mm, length 30 cm), and Shodex® HFIP-803 (diameter 8 mm, length 30 cm). The polymers were detected by an RI detector (differential refractometry). Narrowly distributed polymethyl methacrylate standards with molecular weights Mₙ of from 505 to 2,740,000 were used for calibration. Extrapolation was used for determination in regions of elution lying outside this interval.

The thickness of the polyester films was measured using a Digitrix 2 device from Helios Meβtechnik GmbH u. Co. KG.

The DSC tests were carried out using an Exstar DSC 6200R device from Seiko, as follows:

from 6 to 10 mg of each specimen were heated at a heating rate of 20° C./min from −70° C. to 220° C. The melting point of the specimen is the onset temperature of the respective melting peak. An empty specimen crucible was used as reference.

From 6 to 10 mg of the polymer specimens in each case were heated at a heating rate of 20° C./min from −70° C. to 220° C. and then directly cooled again to −70° C. at a cooling rate of 20° C./min. During each of these cooling procedures the temperature of the start and end of the crystallization was measured (corresponding to the start and end of the crystallization peak). The crystallization time can be calculated from this temperature difference and the cooling rate. An empty specimen crucible was used as reference.

The adhesion properties of the polyester films were determined as follows:

Comparative evaluation of the films took place, based on the perceived adhesion on folding and unfolding the films. On the basis of each evaluation the film was classified into one of the following categories

| | |
|---|---|
| + | moderate adhesion |
| ++ | marked adhesion |
| +++ | very marked adhesion. |

The transparency of the polyester films was determined to ASTM D1003-92 (determining the haze value in %). Each of the films had a thickness of 20 μm.

The antifogging properties of the polyester films were determined as follows:

In a laboratory controlled to 23° C. and 50% relative humidity, film samples, each with a thickness of 20 μm, were held in place with the aid of a rubber band over a transparent 0.5 l drinking glass in which there was 0.1 l of cold mains water. The glasses were stored in a refrigerator with a constant setting of 2° C. and each was removed for observation after 5, 15, 60 and 240 min.

In each case, the condensate which formed on cooling the air at 23° C. to refrigerator temperature was assessed. The film provided with an effective antifogging agent is transparent even after the condensate has formed, since the condensate forms a coherent, transparent film, for example. Without an effective antifogging agent the formation of a fine mist of droplets on the film surface reduces the transparency of the film, and in the worst ase the article packaged in the film can no longer be seen.

The nature of the condensate in each case is evaluated as follows:

| Classification | Description |
|---|---|
| A | opaque, small droplets |
| B | opaque or transparent with large drops |
| C | complete, transparent layer of transparent drops |
| D | transparent film with irregular, large drops |
| E | transparent film, no water visible |

This method of determining the antifogging properties of a film is based on the method described in the brochure “Atmer—Antifog agents for agricultural and food packaging films”, Ciba Specialty Chemicals Inc., Basel, Switzerland, September 1998, and simulates, for example, the formation of condensate on the packaging film after fresh products (fresh meat, cheese, vegetables, mushrooms, fruit) have been packed in a cold store or at a sales counter.

Starting Materials:

Component i1):

P-i-1: To prepare the biodegradable polyester P-i-1, 87.3 kg of dimethyl terephthalate, 80.3 kg of adipic acid, 117 kg of 1,4-butanediol, and 0.2 kg of glycerol were mixed with 0.028 kg of tetrabutyl orthotitanate (TBOT), the molar ratio between alcohol components and acid component being 1.30. The reaction mixture was heated to 180° C. and reacted for 6 h at this temperature. The temperature was then increased to 240° C. and the excess dihydroxy compound was distilled off in vacuo over a period of 3 h. 0.9 kg of hexamethylene diisocyanate was then slowly metered in at 240° C. over a period of 1 h.

The resultant polyester P-i-1 had a melting point of 108° C. and a molar mass (Mₙ) of 23,000 g/mol.

Components ii1:

The components ii1) used were:

P-ii1-1: A polyethylene glycol with an average molar mass of 9000 g/mol and a melting point of about 65° C. (Pluriol® E 9000 from BASF Aktiengesellschaft)

P-ii1-2: A polyethylene glycol with an average molar mass of 8000 g/mol and a melting point of about 63° C. (Pluriol® E 8005 from BASF Aktiengesellschaft)

P-ii1-3: A polyethylene glycol with an average molar mass of 4000 g/mol and a melting point of about 60° C. (Sokolan® SR 100 from BASF Aktiengesellschaft).

P-ii1-4: Polyethoxysorbitan stearate (Tween®60 from ICI America Inc.)

P-ii1-5: Polyethoxysorbitan monooleate (Tween®80 from ICI America Inc.)

The following was used for comparison:

C-ii1-1: A liquid polyethylene glycol with an average molar mass of 600 g/mol and a melting point of about 20° C. (Pluriol® E 600 from BASF Aktiengesellschaft).

Components ii2:

P-ii2-1: To prepare the biodegradable partly aromatic polyester P-ii2-1, 87.3 kg of dimethyl terephthalate, 80.3 kg of adipic acid, and 117 kg of 1,4-butanediol were mixed with 0.028 kg of tetrabutyl orthotitanate (TBOT), the molar ratio between alcohol components and acid component being 1.30. The reaction mixture was heated to 180° C. and reacted for 6 h at this temperature. The temperature was then increased to 240° C. and the excess dihydroxy compound was distilled off in vacuo over a period of 3 h. 6.9 kg of 1,4-butanediol were then added at 220° C. and reacted at this temperature for 2 h. 18.7 kg of pyromellitic dianhydride were then added at 150° C. and reacted at this temperature for 1 h.

The resultant polyester P-ii2-1 had a molar mass (Mₙ) of 2500 g/mol.

Production of the Polyester Films:

To produce the polyester films, the starting materials given in Table 1 were mixed in a twin-screw extruder. In each case here, component ii1) was added in the form of a masterbatch made from 20% by weight ii1) and 80% by weight of i). The resultant molding compositions were processed on a blown-film plant at a melt temperature of 150° C. and with a blow-up ratio of 2.5:1. The films produced had a thickness of about 20 μm.

TABLE 1

| | | | Component | Other |
|---|---|---|---|---|
| | Component i), | Component | ii2), amount | components, |
| | amount in % | ii1) , amount | in % by | amount in % |
| Film | by weight | in % by weight | weight | by weight |
| F-1 | P-i-1, 99.5 | P-ii1-1, 0.5 | — | — |
| F-2 | P-i-1, 99.4 | P-ii1-1, 0.6 | — | — |
| F-3 | P-i-1, 99.5 | P-ii1-2, 0.5 | — | — |
| F-4 | P-i-1, 99.7 | P-ii1-3, 0.3 | — | — |
| F-5 | P-i-1, 99.0 | — | P-ii2-1, 1.0 | — |
| F-6 | P-i-1, 89.5 | P-ii1-2, 0.5 | P-ii2-1, 10.0 | — |
| F-7 | P-i-1, 99.5 | P-ii1-3, 0.5 | — | — |
| F-8 | P-i-1, 99.0 | P-ii1-2, 0.5 | — | — |
| | | P-ii1-3, 0.5 | | |
| F-9 | P-i-1, 99.4 | P-ii1-4, 0.6 | — | — |
| F-10 | P-i-1, 99.4 | P-ii1-5, 0.6 | — | — |
| F-C1 | P-i-1, 100.0 | — | — | — |
| F-C2 | P-i-1, 99.5 | — | — | C-ii1-1, 0.5 |

Polyester Film Properties:

Table 2 gives the properties of the polyester films.

TABLE 2

| | Transparency, | | Anti-fogging¹ after 5, |
|---|---|---|---|
| Film | haze in % | Adhesion¹ | 15, 60 and 240 min |
| F-1 | 3.7 | +++ | n.d.² |
| F-2 | 3.8 | +++ | n.d. |
| F-3 | 3.4 | +++ | n.d. |
| F-4 | n.d. | ++ | n.d. |
| F-5 | n.d. | ++ | n.d. |
| F-6 | 3.0 | +++ | n.d. |
| F-7 | n.d. | n.d. | A, B/C, C/D, C/D |
| F-8 | n.d. | n.d. | A, B/C, B/C, B/C |
| F-9 | 3.2 | +++ | A, B/C, C/D, C/D |
| F-10 | n.d.² | ++ | A, B/C, C/D, C/D |
| F-C1 | 6.3 | + | A, A/B, A/B, B |
| F-C2 | 6.8 | + | n.d. |

¹For the definition of each classification (+ to +++, A to E), see the method description above under “performance tests”.
²n.d. = not determined

The values given in Table 2 confirm the improved properties of the polyester films of the invention.

Table 3 gives DSC measurements and crystallization times for the polyester films.

TABLE 3

| Film | T_{B}¹/° C. | T_{E}²/° C. | T_{C}³/min |
|---|---|---|---|
| F-2 | 90 | 60 | 1.5 |
| F-C1 | 105 | 60 | 2.25 |

¹T_{B} = temperature at start of crystallization
²T_{E} = temperature at end of crystallization
³T_{C} = crystallization time

The values given in Table 3 confirm the suitability of component ii) as a nucleating agent in polyesters.

We claim:

1. A polyester film comprising
i) from 70 to 99.9% by weight of at least one polyester with a molar mass Mₙ in range from 8000 to 100,000 g/mol, and
ii) from 0.1 to 30% by weight of one or more compounds selected from
ii1) at least one surfactant
ii2) polyesters with a molar mass Mₙ in the range from 1000 to 7000 g/mol,
or a mixture made from one or more compounds ii1) and ii2),
where the percentages by weight of components i) to ii) give 100% in total.

2. A polyester film as claimed in claim 1, where the polyester i) or ii2), or the two polyesters i) and ii2), independently of one another, have been built up from:
A) an acid component made from
a1) from 30 to 95 mol % of at least one aliphatic, or at least one cycloaliphatic, dicarboxylic acid, or ester-forming derivatives thereof, or mixtures of these,
a2) from 5 to 70 mol % of at least one aromatic dicarboxylic acid, or an ester-forming derivative thereof, or a mixture of these, and
a3) from 0 to 5 mol % of a compound containing sulfonate groups,
where the molar percentages of components al) to a3) give 100% in total,
B) at least one diol component selected from the group consisting of C₂-C₁₂-alkanediols and C₅-C₁₀-cycloalkanediols and mixtures of these
and, if desired, also one or more components selected from
C) at least one component selected from
c1) dihydroxy compounds containing ether functions and having the formula I
HO—[(CH₂)ₙ—O]ₘ—H (I)
where n is 2, 3 or 4, and m is an integer from 2 to 250,
c2) hydroxycarboxylic acids of the formula IIa or IIb
HO—C(O)-G-O—]ₚH (IIa) 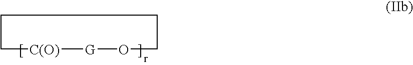
where p is an integer from 1 to 1500, and r is an integer from 1 to 4, and G is a radical selected from the group consisting of phenylene, —(CH₂)_{q}—, where q is an integer from 1 to 5, —C(R)H— and —C(R)HCH₂, where R is methyl or ethyl c3) amino-C₂-C₁₂ alkanols and amino-C₅-C₁₀ cycloalkanols and mixtures of these
c4) diamino-C₁-C₈ alkanes
c5) 2,2′-bisoxazolines of the formula III 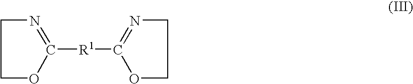
where R¹ is a single bond, (CH₂)_{z} alkylene, where z=2, 3 or 4, or phenylene, and
c6) aminocarboxylic acids selected from the group consisting of the naturally occurring amino acids, polyamides with molar masses of not more than 18000 g/mol obtainable by polycondensing a dicarboxylic acid having from 4 to 6 carbon atoms with a diamine having from 4 to 10 carbon atoms, and compounds of the formulae IVa and IVb
HO—[—C(O)-T-N(H)—]ₛH (IVa) 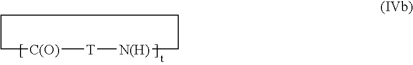
where s is an integer from 1 to 1500 and t is an integer from 1 to 4, and T is a radical selected from the group consisting of phenylene, —(CH₂)ₙ—, where n is an integer from 1 to 12, —C(R²)H— and —C(R²)HCH₂, where R² is methyl or ethyl,
and polyoxazolines having the repeat unit V 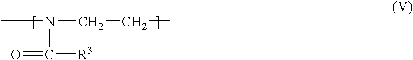
where R³ is hydrogen, C₁-C₆-alkyl, C₅-C₈-cycloalkyl, or phenyl, either unsubstituted or having up to three C₁-C₄-alkyl substituents, or is tetrahydrofuryl,
or a mixture made from cl) to c6) and
D) at least one component selected from
d1) compounds having at least three groups capable of ester formation,
d2) isocyanates, and
d3) divinyl ethers or a mixture made from d1) to d3).

3. A polyester film as claimed in claim 1 or 2, where component iii) is at least one nonionic surfactant.

4. A polyester film as claimed in any of claims 1 to 3, where component ii1) is at least one alkoxylated or non-alkoxylated sugar ester or sugar ether.

5. A polyester film as claimed in any of claims 1 to 4, where component ii1) is at least one polysorbate.

6. A polyester film as claimed in any of claims 1 to 3, where component ii1) is at least one polyalkylene glycol or polyalkylene glycol ester with a molar mass Mₙ in the range from 1000 to 15000 g/mol.

7. A polyester film as claimed in any of claims 1 or 3, where component ii1) is polyethylene glycol or polyethylene glycol ester.

8. A polyester film as claimed in any of claims 1 to 7, where component ii2) is an aliphatic polyester composed of adipic acid and propylene 1,2-glycol.

9. A polyester film as claimed in any of claims 1 to 8, in which a mixture made from one or more compounds ii1) and ii2) is present as component ii).

10. The use of the polyester films as claimed in any of claims 1 to 9 as a packaging film.

11. The use of the polyester film as claimed in any of claims 1 to 9 as a film which preserves freshness.

12. The use of compounds selected from iii) or ii2) or mixtures made from one or more compounds ii1) and ii2), as claimed in any of claims 1 to 9, for increasing the transparency of polyester films.

13. The use of compounds selected from ii1) or ii2) or mixtures made from one or more compounds ii1) and ii2), as claimed in any of claims 1 to 9, as nucleating agents for polyesters.

14. The use of compounds selected from ii1) or ii2) or mixtures made from one or more compounds iii) and ii2), as claimed in any of claims 1 to 9, for increasing the adhesion of polyester films.

15. The use of compounds selected from ii1) or ii2) or mixtures made from one or more compounds ii1) and ii2), as claimed in any of claims 1 to 9, as antifogging agents for polyester films.
